(19) United States
(12) Patent Application Publication
(10) Pub. No.: US 2016/0344262 A1
(43) Pub. Date: Nov. 24, 2016

(54) Internal Ventilation System For An Electric Rotary Machine

(71) Applicant: WEG EQUIPAMENTOS ELETRICOS S.A. - MOTORES, Jaragua Do Sul/SC (BR)

(72) Inventor: Cezário Cassiano Antunes, Jaraguá Do Sul (BR)

(21) Appl. No.: 15/112,587

(22) PCT Filed: Feb. 5, 2014
(86) PCT No.: PCT/BR2014/000039

§ 371 Date: Jul. 19, 2016

(51) Int. Cl. H02K 9/10; H02K 15/00; H02K 15/16; H02K 5/20

(52) U.S. Cl. CPC H02K 9/10; H02K 5/20; H02K 15/0012; H02K 15/165

(57) ABSTRACT

A fan rotor of an inner ventilation system of a rotating electrical machine formed by a preferably flat-profiled disc attached concentrically, preferably interconnected, to the axis of the rotating electrical machine and axially attached to the rotor vanes of the rotating electrical machine.

### FIELD OF APPLICATION

This invention discloses a radial fan rotor of an inner ventilation system of a rotating electrical machine formed by a preferably flat-profiled disc attached concentrically to the axis of the rotating electrical machine and axially attached to the rotor vanes of the rotating electrical machine. In another aspect of the invention, it is disclosed a rotating electrical machine comprising the system proposed herein.

### BACKGROUND OF THE INVENTION

In rotating electrical machines, the presence of an effective heat exchange system is essential for maintaining the temperature of components of the rotating electrical machine within nominal operating conditions specified by the project. Although rotating electrical machines operate at high performance levels, a fraction of the electric energy, when converted to mechanical energy, or vice-versa, ends up as thermal energy.

The removal of thermal energy from the inside of a rotating electrical machine may take place either directly or indirectly.

Direct removal of the thermal energy occurs in open drip-proof (ODP) rotating electrical machines, in other words, through direct contact of a cooling fluid (usually air) with the machine components, in particular coil heads, stator, rotor and short-circuit rings, as these components are responsible for the conversion process of electric energy into thermal energy. In doing that, thermal energy is directly transferred to the cooling fluid, which is constantly renovated. The main physical mechanism through which the transition of thermal energy from the machine components to the cooling fluid takes place is called forced convection and depends basically on the surface area of heat exchange in contact with the cooling fluid and on the speed of this fluid over the surface, in which different combinations of these two parameters yield different heat exchange coefficient values.

Indirect removal of thermal energy occurs in totally enclosed (TE) rotating electrical machines. In this case, there are usually two cooling circuits, one inside and another one outside of the machine and the fluids (usually air) of each circuit do not contact each other.

In the internal circuit, air is dislocated by the pressure difference generated by the inner ventilation system, promoting the contact of the cooling fluid with the machine components, in particular coil heads, stator, rotor and short-circuit rings. The cooling fluid removes thermal energy from the surface of these components and transfers said energy to the surface of a solid, in which usually the solid materials are the housing and the covers of the rotating electrical machine. In turn, the housing and the covers contact the external cooling circuit. About the internal ventilation circuit, it should also be mentioned that this circuit may or may not promote communication between the inner portion of cooling fluid present on the front and rear sections of the machine of the rotating electrical machine. In the internal circuit, the main removal mechanism of thermal energy from the components of the rotating electrical machine is also the forced convection mechanism.

The presence of the internal ventilation circuit helps reduce and uniform the temperature distribution inside the rotating electrical machine, eliminating localized thermal energy concentrations that cause hot spots.

The external cooling system usually has an outer ventilation system that generates a pressure difference, resulting in the dislocation of the cooling fluid (usually air) over the solid surface that forms the enclosure of the rotating electrical machine. The thermal energy is removed from the solid surface and transferred to the external cooling fluid. The transfer of thermal energy from the internal circuit to the external cooling circuit takes place through the solid structure, made possible by the thermal conduction mechanism.

### DESCRIPTION OF THE STATE OF THE ART

In the state of the art, there are many proposals for application of the inner ventilation system in rotating electrical machines. Usually, the inner ventilation systems, where communication occurs between the internal cooling fluid portions in the front and rear sections respectively of the rotating electrical machine, are comprised of a fan rotor with specific geometry and an extension duct, which aims to connect the fan rotor to the rotor of the rotating electrical machine. In turn, the machine rotor has through-holes for passing the cooling fluid, which enables communication between the front and rear portions of cooling fluid, or vice-versa, of the rotating electrical machine. The return of the cooling fluid from the front portion to the rear portion, or vice-versa, is ensured by a communication channel on the housing of the rotating electrical machine.

Document U.S. Pat. No. 5,747,900 proposes an air-cooled rotating electrical machine, which describes an inner ventilation system comprised of a fan rotor positioned in the rear part of the rotating electrical machine. Internally, the rotating electrical machine is built with ducts on its housing, stator and rotor, allowing air circulation. On both front and rear portions of the housing of the rotating electrical machine there are plates with a plurality of holes. Thus, the rotating electrical machine is cooled by forced convection of the ambient air.

The utility model CN202183712 features a modified rotor for a rotating electrical machine with ventilation channels in the rotor itself, in which a fan rotor is attached to one of the ends. With this format, the ventilation system is attached to the rotor of the rotating electrical machine, which reduces the amount of parts and simplifies the construction.

Similarly, the utility model CN201403011 reveals a ventilation structure for the rotor of the rotating electrical machine. The rotor structure has ventilation channels and aluminum blades are integrated to the rotor. In this configuration, the rotor of the rotating electrical machine is responsible for the movement of the cooling fluid in the internal ventilation circuit, eliminating the need for a dedicated component.

The utility mode CN201260067 features a rotating electrical machine with simultaneous heat exchange on the front and rear sections of the engine, which increases machine efficiency. In this project, the projections on both ends of the rotor cage are integrated with the structures of the internal blades, which increases cooling through air circulation in the channels.

Alternatively, the utility model CN202160076 describes a disc with holes for balancing the structure of the rotating electrical machine, which is used to reduce engine vibration during operation.

In light of the above, the documents bring solutions that aim to modify the cooling system in order to reduce complexity, the amount of parts and building and maintenance costs of electric engines.

Thus, a demand exists for approaches that provide a solution regarding heat exchange without procedural and economic impact in the manufacturing of rotating electrical machines.

From a dynamic point of view, the fan rotors adopted in the state of the art are manufactured separately and subsequently assembled. These rotors have considerable, usually complex, geometry and dimensions, which usually tend to result in residual unbalances. Thus, previous balancing processes are needed for the fan rotor prior to mounting on the rotor of the rotating electrical machine.

### BRIEF DESCRIPTION OF THE DRAWINGS

FIG. 1 shows a perspective, cross-sectional view of the rotating electrical machine with the inner ventilation system.

FIG. 2 shows a perspective view of the assembly of the rotor (0) of the rotating electrical machine and the fan rotor of the inner ventilation system.

FIG. 3 shows a sectional, perspective view of the assembly of the rotor (0) of the rotating electrical machine and the fan rotor of the inner ventilation system.

FIG. 4 shows a cross section of the rotating electrical machine, with an internal flow assembly of the cooling fluid provided by the inner ventilation system.

### DETAILED DESCRIPTION OF THE DRAWINGS

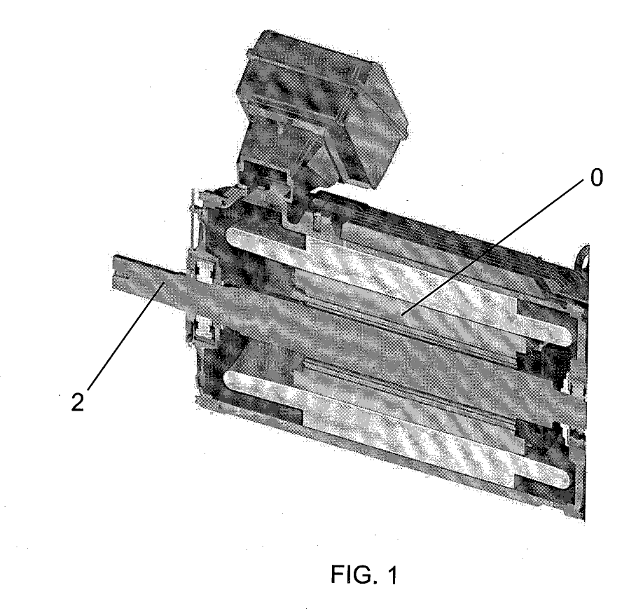

Considering FIGS. 1 to 3, said system comprises a preferably flat-profiled disc (3) with a plurality of holes attached to the vanes (1) of the rotor (0) of the rotating electrical machine.

FIG. 1 illustrates the position of the rotor (0) of the rotating electrical machine with the inner ventilation system inside the rotating electrical machine positioned concentrically to the axis (2) of the machine.

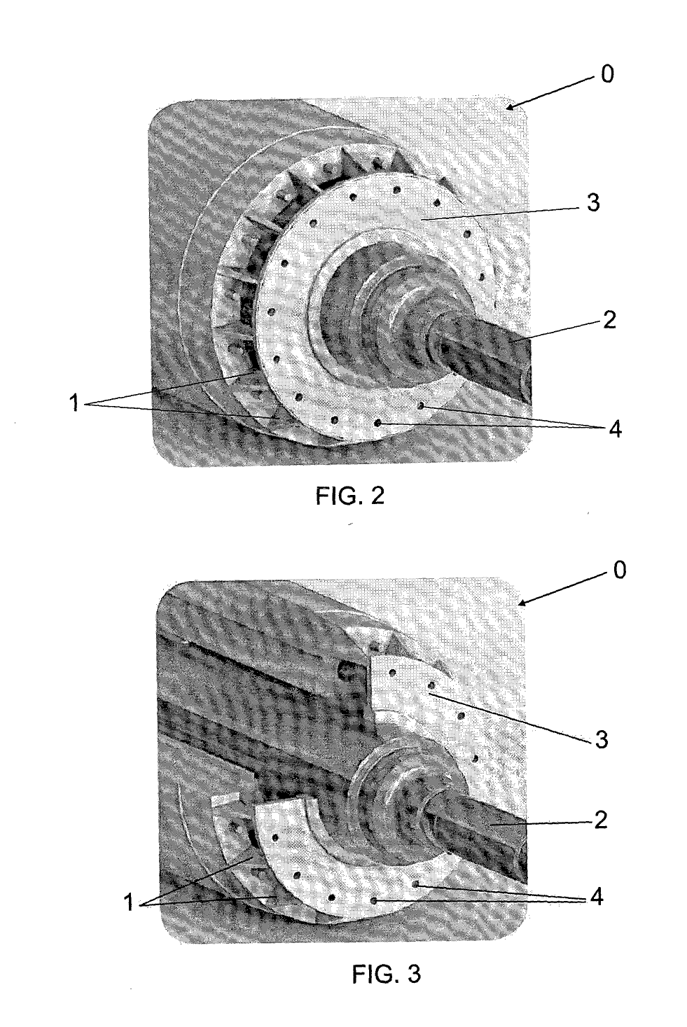

FIGS. 2 and 3 illustrate a preferable construction of the rotor (0) of the rotating electrical machine comprising a preferably flat-profiled disc (3) attached to the vanes (1) concentrically to the axis (2) of the rotor of the rotating electrical machine. IN this configuration, the vanes (1) of the rotor of the rotating electrical machine function as the blades of a radial fan rotor.

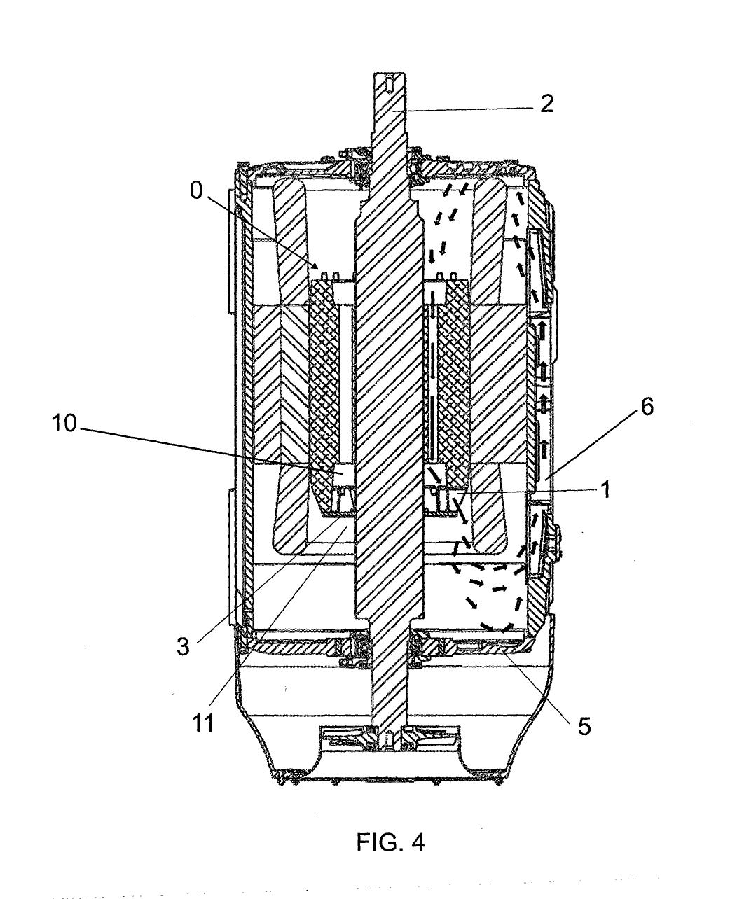

FIG. 4 shows the flow of cooling fluid inside the machine housing, when the system uses air as the cooling fluid.

### OBJECTIVE OF THE INVENTION

The invention seeks to solve a problem of the state of the art, revealing an inner ventilation system of simple assembly, in which part of the fan rotor is comprised by the rotor (0) of the rotating electrical machine, specifically by the vanes (1) and by the preferably flat-profiled disc (3).

This invention discloses a radial fan rotor of an inner ventilation system of a rotating electrical machine. The rotor is comprised of a preferably flat-profiled disc (3) attached concentrically to the axis of the rotating electrical machine (2) and axially to the vanes (1) of the rotor (0) of the rotating electrical machine. The connection of this disc to the vanes (1) of the rotor (0) of the rotating electrical machine forms a radial fan rotor, of low complexity and cost, since the vanes are formed at the moment of injection of the squirrel cage of the rotor (0) of the rotating electrical machine, which may also be formed by any methods which lead to obtaining the vanes.

During the operation of the rotating electrical machine, the rotating movement of the rotor (0) of the rotating electrical machine simultaneously activates the fan rotor, which is formed by the preferably flat-profiled disc (3) and the vanes (1) of the rotor (0). The rotating movement leads to pressure reduction upstream (10) of the fan rotor and pressure increase downstream (11). This pressure difference promotes dislocation of the cooling fluid located inside the rotating electrical machine. The path crossed by the cooling fluid comprises passing through the inside of the rotor (0) of the rotating electrical machine, conducted towards the fan rotor, which is formed by the preferably flat-profiled disc (3) and by the vanes (1) of the rotor (0). Afterwards, this flow is driven towards the cover (5) of the rotating electrical machine, taking a detour to a duct (6) located on the machine housing. This duct (6) directs the flow to the opposite part of the machine, where the flow is once again directed through the inside of the rotor (0) of the rotating electrical machine, restarting the cycle.

In addition, the same preferably flat-profiled disc (3) may function as a balancing disc through the addition of a plurality of holes.

From the fluid dynamic point of view, this invention is simple, since the fan rotor is formed, solely, by the vanes (1) of the rotor (0) of the rotating electrical machine and by a preferably flat-profiled disc (3) attached to each other. In this manner, the rotor component of the fan ceases to exist on its own, and becomes the result of the coupling of two components, the preferably flat-profiled disc (3) and the vanes (1) of the rotor (0) of the rotating electrical machine.

The vanes (1) of the rotor of the rotating electrical machine are obtained, preferably, through a pressure injection procedure, and the tool used to shape these vanes (1) is preferably manufactured through a precision machining procedure, resulting in low residual unbalance. The preferably flat-profiled disc (3) has simple geometry, also resulting in low residual unbalance. This way, the need of balancing prior to the final assembly process of the rotor (0) of the rotating electrical machine is eliminated.

1. An inner ventilation system for a rotating electric machine comprising an engine rotor, a plurality of vanes and a preferably-flat-profiled disc attached to each other, rotating together when the engine rotor is rotated, making the vanes function similarly to the blades of a fan.

2. The inner ventilation system according to claim 1, wherein the profiled disc is a flat-profiled disc comprising a plurality of holes, which enable balancing of the rotor of the rotating electrical machine.

3. The inner ventilation system according to claim 2, wherein the preferably flat-profiled disc is manufactured from a metallic material.

4. The inner ventilation system according to claim 2, wherein the flat-profiled disc is manufactured from a non-metallic material.

5. The inner ventilation system according to claim 1, wherein the shape and disposition of the vanes result in a radial fan rotor with straight blades.

6. The inner ventilation system according to claim 1, wherein the shape and disposition of the vanes result in a radial fan rotor with tilted blades.

7. The inner ventilation system according to claim 1, wherein the disc has a flat profile on the region in contact with the vanes.

8. The inner ventilation system according to claim 2, wherein the flat-profiled disc is formed by a single or segmented component.
